(19) United States
(12) Patent Application Publication
(10) Pub. No.: US 2007/0211300 A1
(43) Pub. Date: Sep. 13, 2007

(54) Cover of an office machine

(75) Inventor: Yi-Sung Chen, Taipei (TW)

Correspondence Address: LADAS & PARRY, 26 WEST 61ST STREET, NEW YORK, NY, 10023, US

(73) Assignee: BENQ CORPORATION

(21) Appl. No.: 11/714,396

(22) Filed: Mar. 6, 2007

(30) Foreign Application Priority Data
Mar. 7, 2006 (TW) 95107624

(51) Int. Cl. H04N 1/23

(52) U.S. Cl. 358/302

(57) ABSTRACT

A cover of an office machine utilized for pressing a document on a glass plate is provided. The cover has a platform, a film, and a handle. The platform has a compressible layer for pressing the document on the glass plate. The film is located on a lower surface of the compressible layer for flattening the document. The handle is pivotally connected to an edge of the platform. The handle also connects to the film. As the handle is lifted, the film is elastically deformed to have air injected between the film and the glass plate.

### BACKGROUND OF THE INVENTION

(1) Field of the Invention

This invention relates to an office machine and a cover thereof, and more particularly relates to an office machine preventing the cover stick to a glass plate due to vacuum created by the office machine.

(2) Description of the Related Art

A scanner is not an easy peripheral device to reach for early computer users. Due to the limitations of high price and operation difficulty, scanners are only applied for professional image processing in early years. However, under the progressive of digital image technology, cheaper scanners are available and have become an indispensable device for personal or small office users.

FIG. 1 is a cross-section view of a cover 10 of a typical scanner. As shown, the scanner is pivotally connected to a platform 20 of the scanner. The platform 20 has an upper case 21 with an opening 21a therein. A glass plate 22 is assembled upward and fixed inside the opening 21a for supporting documents (not shown). The cover 10 has a main body 12, a sponge layer 14, and a film 16. The sponge layer 14 is positioned therebelow the main body 12 for uniformly pressing the document on the glass plate 22. The film 16 covers a lower surface of the sponge layer 14 for flattening the document.

As the cover is rest on the platform and no document is loaded, the film 16 contacts the glass plate 22 directly. Since both the contact surfaces of the film 16 and the glass plate 22 have high flatness, the air therebetween would be completely exhausted to result in vacuum and influence the lifting of the cover 10.

For solving this problem, another typical scanner is provided in FIG. 2. As shown, the cover 10 is pivotally connected to the platform 20. The cover 10 has a main body 12, a sponge layer 14, and a film 18. The sponge layer 14 is positioned therebelow the main body 12 for uniformly pressing the document on the glass plate 22. The film 18 covers a lower surface of the sponge layer 14 for flattening the document.

The film 18 features a size greater than the size of the opening 21a of the upper case 21 of the platform (which relates to the size of scanning area). Therefore, the boundary of the film 18 extended on the nearby upper case 21 is bent to form a gap between the film 18 and the glass plate 22, which allows air injecting therein to prevent vacuum from happening.

However, due to the bent near the boundary of the film 18, the document may not be perfectly flattened by the film 18, especially near the edges of the opening 21a. Thus, there shows a problem about focusing for document to be scanned.

Accordingly, the present invention provides a cover to overcome the problem of vacuum absorbing event but showing no bad influence to the scanned image.

### SUMMARY OF THE INVENTION

It is a main object of the present invention to provide a cover for effectively flattening the document to guarantee scanning quality.

It is another main object of the present invention to prevent the cover being absorbed on the glass plate due to vacuum absorbing event.

A cover of an office machine for pressing a document on a glass plate is provided in the present invention. The cover has a main body, a film, and a handle. The main body has a compressible layer for pressing the document on the glass plate. The film is located on a lower surface of the compressible layer for flattening the document. The handle is pivotally connected to an edge of the main body and connected to a boundary portion of an upper surface of the film. As the handle is lifted, the handle is rotated with respect to the main body and the film is elastically deformed to have air injected between the film and the glass plate.

An office machine is also provided in the present invention. The office machine has a platform, a main body, a film, and a handle. The platform has a glass plate for supporting a document. The main body is pivotally connected to the platform for pressing the document on the glass plate. The main body also has a compressible layer for pressing the document on the glass plate. The film is located on a lower surface of the compressible layer for flattening the document. The handle is pivotally connected to an edge of the main body and connected to the boundary portion of an upper surface of the film. As the handle is lifted, the handle is rotated with respect to the main body and the film is elastically deformed to have air injected between the film and the glass plate.

### BRIEF DESCRIPTION OF THE DRAWINGS

The present invention will now be specified with reference to its preferred embodiment illustrated in the drawings, in which:

FIG. 1 shows a cross-section view of a cover of a typical scanner;

FIG. 2 shows a cross-section view of a cover of another typical scanner;

FIG. 3A shows a cross-section view of a preferred embodiment of an office machine in accordance with the present invention;

FIG. 3B shows an explosive view of the cover of FIG. 3A; and

FIGS. 4A and 4B are schematic views showing the lifting of the handle forming a gap between the film and the glass plate by using the cover in accordance with the present invention.

### DESCRIPTION OF THE PREFERRED EMBODIMENTS

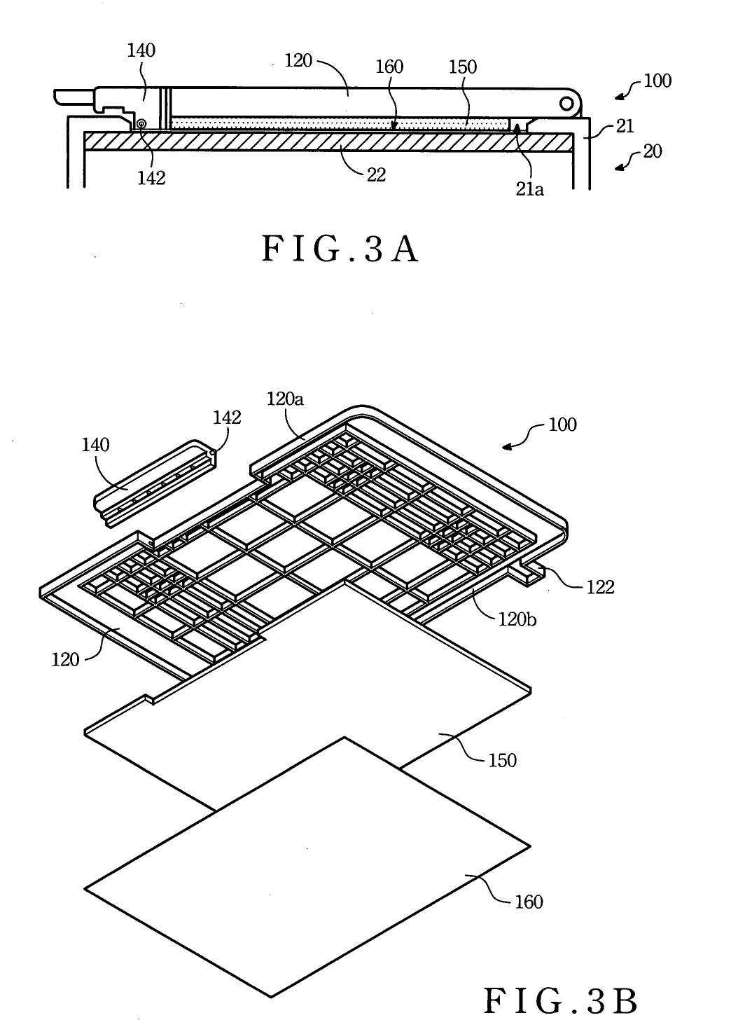

FIG. 3A shows a preferred embodiment of an office machine in accordance with the present invention. As shown, the office machine is composed of a platform 20 and a cover 100. The platform 20 has an upper case 21 and a glass plate 22. The upper case 21 has an opening 21a therein, so as to have the glass plate 22 assembled upward and fixed inside the opening 21a to support a document to be scanned. The cover 100 for pressing the document on the glass plate 22 is pivotally connected to the platform 20 by using a shaft (not shown).

FIG. 3B shows an explosive view of the above mentioned cover 100. As shown, the cover 100 has a main body 120, a compressible layer 150, a film 160, and a handle 140. The main body 120 has a first pivotally connecting portion 122 on a rear edge 120b thereof for pivotally connected to the platform 20. The compressible layer 150, such as a sponge layer, is located below the main body 120 for uniformly pressing the document on the glass plate 22. The film 160 is located on and covers a lower surface of the compressible layer 150 for flattening the document. The handle 140 is pivotally connected to a front edge 120a of the main body 120, which is opposite to the rear edge 120b where the first pivotally connecting portion 122 is formed.

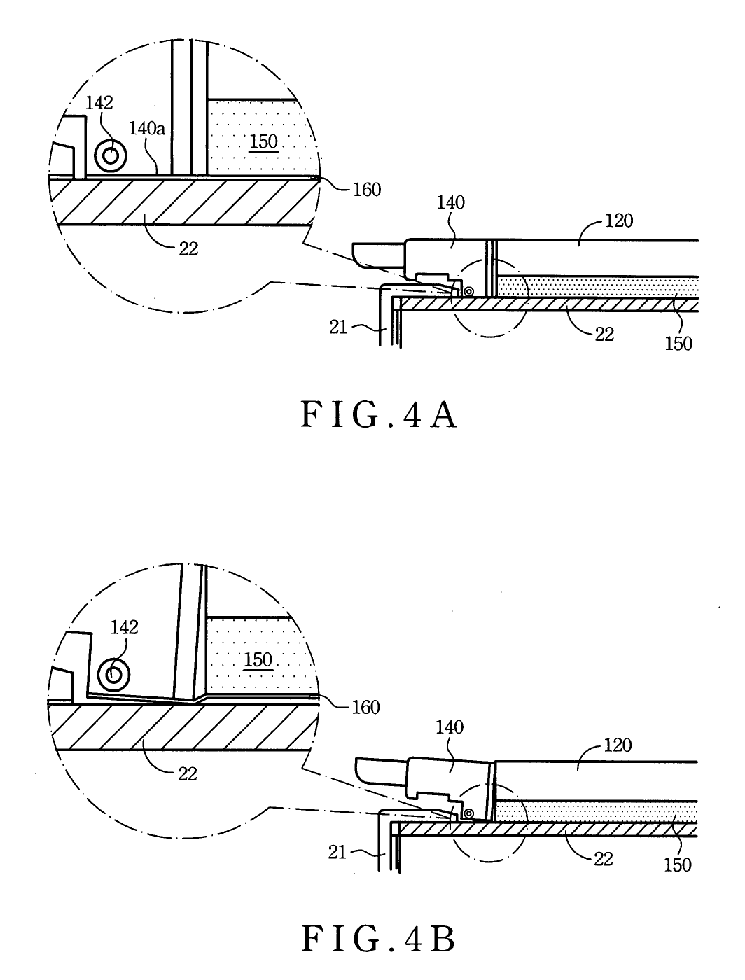

FIG. 4A shows a cross-section view of a preferred embodiment of the handle 140. As shown, the handle 140 is pivotally connected to the main body by using a shaft 142. The shaft 142 acting as a center of rotation for the handle 140 with respect to the main body 120 is located near the boundary of the film 160. In addition, the lower surface 140a of the handle 140 is attached to the boundary portion of the upper surface of the film 160. Also referring to FIG. 4B, the lifting of the handle 140 has the handle 140 rotated centered at the shaft 142 with respect to the main body 120. At the same time, the lower surface 140a of the handle 140 together with the attached portion of the film 160 moves downward with respect to the main body 120 to form a gap between the film 160 and the glass plate 22 allowing air to be injected between the film 160 and the glass plate 22.

Basically, during the lifting of the handle 140 as shown in FIGS. 4A and 4B, the deformation of the film 160 must be restricted in the elastic region to prevent permanent deformation. The rotation angle of the handle 140 is thus restricted by the range of deformation in the elastic region of the film 160. Thereby, as the handle backs to the position of FIG. 4A, the film 160 may recover its initial size for effectively flattening the document.

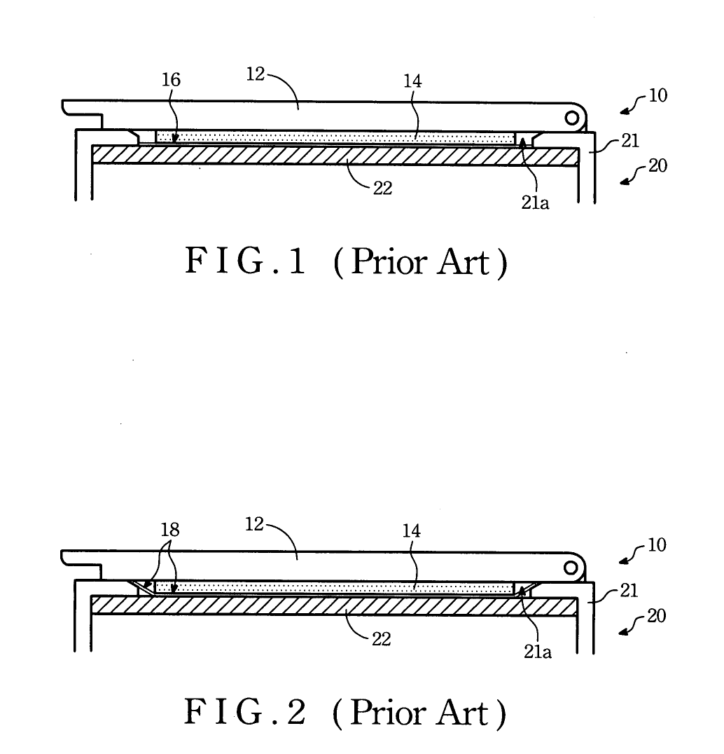

The cover 10 of the typical scanner as shown in FIG. 1 has a main problem that as no document is loaded, the film 16 is absorbed on the glass plate 22 and the lifting of the cover 10 becomes difficult. In contrast, the present invention as shown in FIGS. 4A and 4B features a handle 140 as a lever to overcome the vacuum absorbing event between the film 160 and the glass plate 22 and prevent the problem from happening.

Moreover, the cover 10 of the typical scanner as shown in FIG. 2 with a greater film 18 to prevent vacuum absorbing event has a problem that the document near the edge of the opening 21a cannot be effectively flattened, which influences the focusing of the document to be scanned. In contrast, as shown in FIG. 3A, the film 160 provided in the present invention is not larger than the size of the opening 21a to make sure that the document can be effectively flattened by the film 160 and the problem about focusing can be prevented.

While the embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A cover of an office machine, for pressing a document on a glass plate, the cover comprising:
a main body, having a compressible layer for pressing the document on the glass plate;
a film, located on a lower surface of the compressible layer for flattening the document; and
a handle, pivotally connected to an edge of the main body and connected to a boundary portion of an upper surface of the film;
wherein, as the handle is lifted, the handle rotates with respect to the main body and the film is deformed to have air injected between the film and the glass plate.

2. The cover of claim 1 wherein the compressible layer is a sponge layer.

3. The cover of claim 1 wherein the glass plate is located on a platform of the office machine and the main body is pivotally connected to the platform of the office machine.

4. The cover of claim 3 wherein the edge of the main body to which the handle is connected is opposite to an edge of the main body pivotally connected to the platform.

5. The cover of claim 1 wherein the handle is pivotally connected to the main body through a shaft near the boundary of the film, and as the handle is lifted, the film attached to the handle is moved downward with respect to the main body.

6. An office machine comprising:
a platform, having a glass plate for supporting a document; and
a cover, comprising:
a main body, pivotally connected to the platform, and having a compressible layer for pressing the document on the glass plate; and
a film, located on a lower surface of the compressible layer for flattening the document; and
a handle, pivotally connected to an edge of the main body and attached to a boundary portion of an upper surface of the film;
wherein, as the handle is lifted, the handle rotates with respect to the main body and the film is deformed to have air injected between the film and the glass plate.

7. The office machine of claim 6 wherein the compressible layer is a sponge layer.

8. The office machine of claim 6 wherein the glass plate is located on the platform and the main body is pivotally connected to the platform.

9. The office machine of claim 8 wherein the edge of the main body to which the handle is connected is opposite to an edge of the main body pivotally connected to the platform.

10. The office machine of claim 6 wherein the handle is pivotally connected to the main body through a shaft near the boundary of the film, and as the handle is lifted, the film attached to the handle is moved downward with respect to the main body.

11. The office machine of claim 6 wherein a rotation angle of the handle with respect to the main body is restricted by the range of elastic deformation of the film.
